(19) United States
(12) Patent Application Publication
(10) Pub. No.: US 2005/0229221 A1
(43) Pub. Date: Oct. 13, 2005

(54) System and method for low-delay channel hopping

(75) Inventors: Louis Joseph Kerofsky, Camas, WA (US); Shawmin Lei, Camas, WA (US)

Correspondence Address: Gerald W. Maliszewski, P.O. Box 270829, San Diego, CA, 92198-2829, US

(73) Assignee: Sharp Laboratories of America Inc.

(21) Appl. No.: 10/818,335

(22) Filed: Apr. 5, 2004

(51) Int. Cl. H04N 7/173; H04N 7/16

(52) U.S. Cl. 725/100; 725/135; 725/131

(57) ABSTRACT

A system and method are provided for low-delay channel changes in a multicast/broadcast of compressed video. The method comprises: receiving a multicast/broadcast with a plurality of compressed video channels; buffering information from a plurality of channels; selecting a channel; and, decoding the selected channel in response to the buffered information. In some aspects, the method pre-identifies access points in the buffered information for each channel, prior to selecting the channel. Then, decoding the selected channel in response to the buffered information includes: accessing the buffered information at the pre-identified access point; and, decoding the selected channel, beginning at the access point. Alternately, access points are not pre-identified. Then, decoding the selected channel in response to the buffered information includes: discovering an access point in the information buffered for the selected channel subsequent to selecting the channel; and, decoding the selected channel, beginning at the discovered access point.

### BACKGROUND OF THE INVENTION

1. Field of the Invention

This invention generally relates to image and video compression coding and, more particularly, to a system and method for minimizing the delay associated with decoded video channels after a specific channel is selected.

2. Description of the Related Art

This invention addresses the problem of channel change in the broadcast or multicast streaming of compressed digital video. When a decoder receiving one channel, switches to another channel, a significant delay occurs before the new channel is buffered, decoded and played back. This delay is very annoying to a viewer, especially a channel surfer. To understand the behavior of a typical digital decoder during a channel change, the main sources of channel changing delay must be understood.

Digital video compression, such a motion pictures expert group (MPEP)-1, MPEG-2, MPEG-4 H.261, H.263, and H.264, exploit temporal correlation between frames. A frame is predicted from prior decoded frames, and the use of prediction significantly reduces the number of bits needed to represent a frame. Temporal dependency between frames implies that a decoder cannot reconstruct a current frame that depends upon earlier frames that have not been received. Thus, a decoder must begin the decoding process with an Intra-type frame, a frame that does not depend upon prior frames. A common technique exists that permits a decoder to tune into a compressed stream when predictive frames are used. This technique periodically codes frames without temporal prediction, so that frames can be decoded without reference to any previously decoded frames. In MPEG, the concept of Group Of Pictures (GOP) provides access points by periodically inserting I-frames (i.e., Intra-coded frames) that can be decoded independently. When a decoder tunes to a channel, the video signal is unavailable until the decoder receives an I-frame. The data dependency introduces a time delay responsive to the frequency of I-frames in the data. A second source of delay is caused by the need to buffer data before decoding, to avoid a situation where a frame is needed for display, but its coded representation has not yet been received.

FIG. 5 is a schematic block diagram illustrating a conventional compressed video decoding system (prior art). When switching from channel X to a channel Y, where the channels are compressed digital video, digital cable, or satellite communications, a typical decoder takes the following actions:
Playback of channel X (initial condition);
Channel change from X to Y;
Freeze screen (typically a black frame is presented);
Search for an I-frame for channel Y;
With an I-frame received, wait until the pre-roll buffer size is reached for channel Y;
Begin Playback of channel Y, beginning with the I-frame.

Delay is introduced when the decoder searches for an I-frame, waits for data to arrive as needed, and waits for the pre-roll buffer size to be reached. There is also a small decoding delay, but it is usually negligible compared to other delays. Electronic Programming Guides, EPGs, have been suggested as a way to minimize the need for conventional channel surfing. However EPGs have not eliminated a user's desire to channel surf, which leaves channel surfing delay a significant drawback associated with digital video broadcast.

It would be advantageous if the time delay associated with compressed video channel changes could be minimized or eliminated.

### SUMMARY OF THE INVENTION

To address the delay associated with changing channels, the present invention buffers compressed data from one or more channel(s) not currently being decoded, in anticipation of a change to one of the buffered channel. When a channel change is initiated, the decoder locates an access point, such as an I-frame held in the buffer, and immediately begins decoding, starting at the location of the most recently received I-frame. This invention defines how data is buffered and how a decoder accesses this buffered data in response to a channel change. The present invention significantly reduces the delay in changing channels. In some aspects, the core idea of buffering non-active input streams is further enhanced. To limit complexity, a subset of possible channels can be buffered. The selection of this subset can be made based upon specified or learned user preferences. The buffering can simply hold a given quantity of data or actively identify the I-frames in the buffer. Thus, there is no need to search the buffer for an I-frame when changing channels, further reducing delay. In contrast to conventional approaches, this is a decoder-only functionality and does not require any changes to an encoder or transport stream.

Accordingly, a method is provided for low-delay channel changes in a multicast/broadcast of compressed video. The method comprises: receiving a multicast/broadcast with a plurality of compressed video channels; buffering information from a plurality of channels; selecting a channel; and, decoding the selected channel in response to the buffered information.

In some aspects, the method pre-identifies access points in the buffered information for each channel, prior to selecting the channel. Then, decoding the selected channel in response to the buffered information includes: accessing the buffered information at the pre-identified access point; and, decoding the selected channel, beginning at the access point. Alternately, access points are not pre-identified. Then, decoding the selected channel in response to the buffered information includes: discovering an access point in the information buffered for the selected channel subsequent to selecting the channel; and, decoding the selected channel, beginning at the discovered access point.

In one aspect of the method, the compressed video channels are serially demultiplexed to extract program streams. Alternately, the compressed video channel transport streams are parallely demultiplexed to extract the program streams.

Additional details of the above described method and a system for low-delay channel changes are presented below.

### BRIEF DESCRIPTION OF THE DRAWINGS

FIG. 1 is a schematic block diagram of the present invention system for low-delay channel changes.

FIG. 2 is a schematic block diagram illustrating a first aspect of the system of FIG. 1.

FIG. 3 is a schematic block diagram illustrating a second aspect of the system of FIG. 1.

FIG. 4 is a schematic block diagram illustrating a third aspect of the system of FIG. 1.

FIG. 5 is a schematic block diagram illustrating a conventional compressed video decoding system (prior art).

FIG. 6 is a flowchart illustrating the present invention method for low-delay channel changes in a multicast/broadcast of compressed video.

FIG. 7 is a flowchart illustrating an alternate aspect to the method of FIG. 6.

### DETAILED DESCRIPTION OF THE PREFERRED EMBODIMENTS

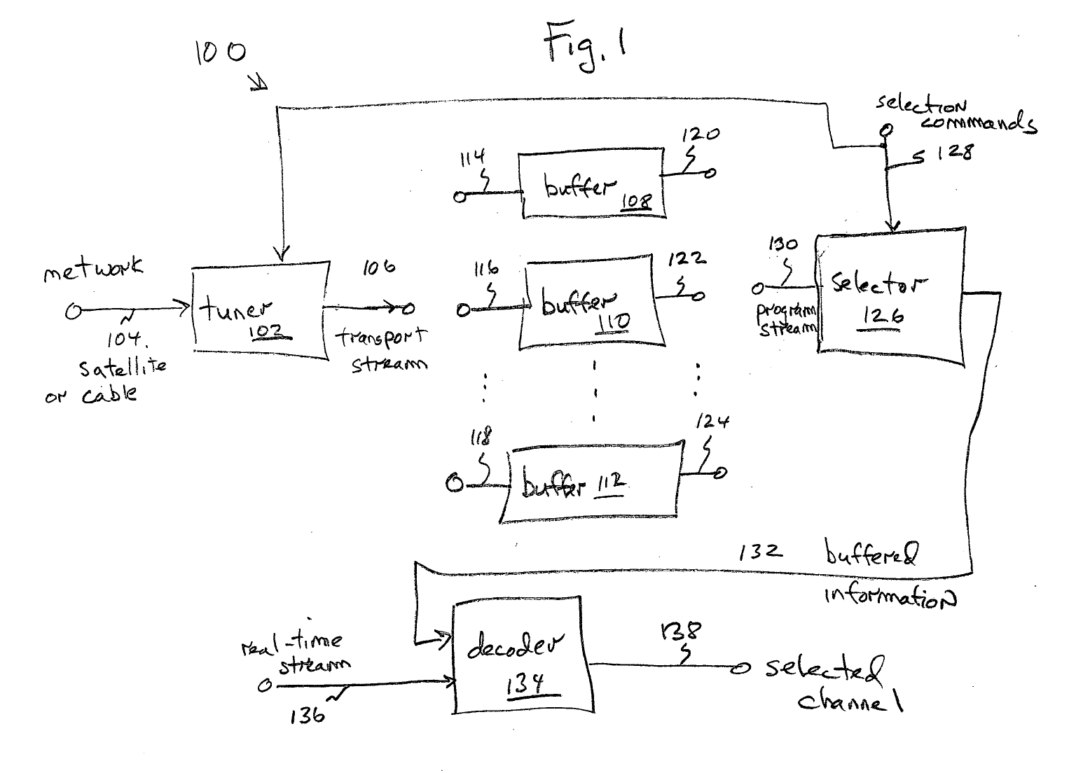

FIG. 1 is a schematic block diagram of the present invention system for low-delay channel changes. The system 100 comprises a tuner 102 having a network interface on line 104 to receive a multicast/broadcast with a plurality of compressed video channels and an interface on line 106 to supply transport streams. The line 104 may represent a digital TV cable or satellite video interface, for example, to receive compressed video channels in a format such as MPEG-1, MPEG-2, MPEG-4, H.261, H.263, or H.264. However, the system has application to any compressed video format that uses predictive frames in the encoding/decoding process. In some aspects, line 104 may be connected to multiple sources, or selectively connected to different sources. For example, line 104 may simultaneously supply compressed video information from both a satellite and cable source, or from two different cable sources.

The system includes a plurality of buffers. Shown are three buffers, buffer 108 through buffer 112. However, the system 100 is not limited to any particular number of buffers. The buffers 108-112 buffer either transport streams or program streams, depending of the placement of the demultiplexer (not shown), as is explained in more detail below.

Each buffer 108-112 has an interface on lines 114 through 118, respectively, to receive information for a corresponding compressed video channel. Each buffer 108-112 has an interface 120 through 124, respectively, to supply the buffered information. A selector 126 has an interface on line 128 to receive channel selection commands and an interface on line 130 connected to the plurality of buffers 108-112. The selector 126 supplies the buffered information at an output on line 132, in response to channel selection commands received on line 128.

A decoder 134 has an interface on line 132 to receive buffered information from the selector 126 and an interface on line 136 connected to receive a real-time compressed video channel program stream. In some aspects, the real-time compressed video line 136 is not present. The decoder 134 supplies the selected channel at an output on line 138, decoded using the buffered information.

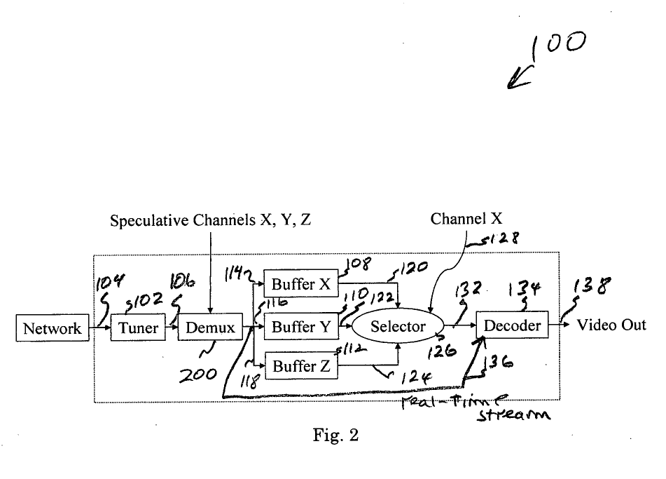

FIG. 2 is a schematic block diagram illustrating a first aspect of the system of FIG. 1. The system 100 further comprises a demultiplexer 200 having an interface on line 106 to receive transport streams from the tuner 102. The demultiplexer (Demux) 200 has an interface on lines 114-118 to supply information (program streams), extracted from the transport stream, to the buffers 108-112.

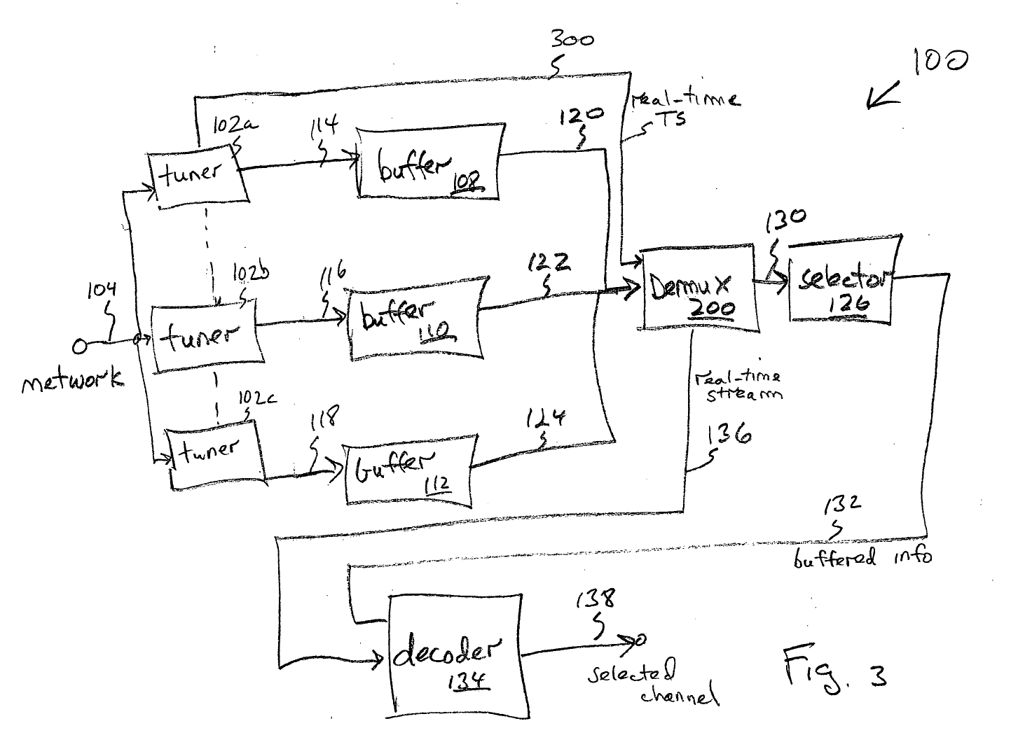

FIG. 3 is a schematic block diagram illustrating a second aspect of the system of FIG. 1. In this aspect, the demultiplexer 200 has an interface on lines 120-124 to receive buffered transport streams from the buffers 108-112, respectively. Likewise, the buffers 108-112 are supplied with transport streams on lines 114-118, respectively, from tuners 102a through 102c respectively. Optionally, one of the tuners supplies a real-time transport stream on line 300. The demultiplexer 200 has an interface on line 130 to supply information (program streams), extracted from the transport stream, to the selector 126. Note, in other aspects of the system not shown, the demultiplexer 200 may be interposed between the selector 126 and the decoder 134.

Referencing either FIG. 1, 2, or 3, in one aspect of the system the selector 126, prior to receiving channel selection commands, pre-identifies access points in the buffered information for each channel. Then, the decoder 134 accesses the buffered information at the pre-identified access point and decodes the selected channel, beginning at the access point. The pre-identification process helps eliminate delays associated with the decoder 134 searching for the access point. Alternately, the decoder 134, subsequent to receiving the buffered information from the selector 126, discovers an access point in the information buffered for the selected channel and decodes the selected channel, beginning at the discovered access point.

If the tuner 102 receives MPEG compressed video channels, then the decoder 134 supplies the selected channel decoded in response to an Intra-coded frame (I-frame) in the buffered information. If the tuner 102 receives H.264 compressed video channels, the decoder 134 supplies the selected channel decoded in response to an Independent Decoder Refresh (IDR) picture in the buffered information.

As shown in FIG. 2, the tuner 102 serially processes the plurality of received compressed video channels and the demultiplexer 200 serially processes the plurality of transport streams. An alternate parallel processing system is presented below.

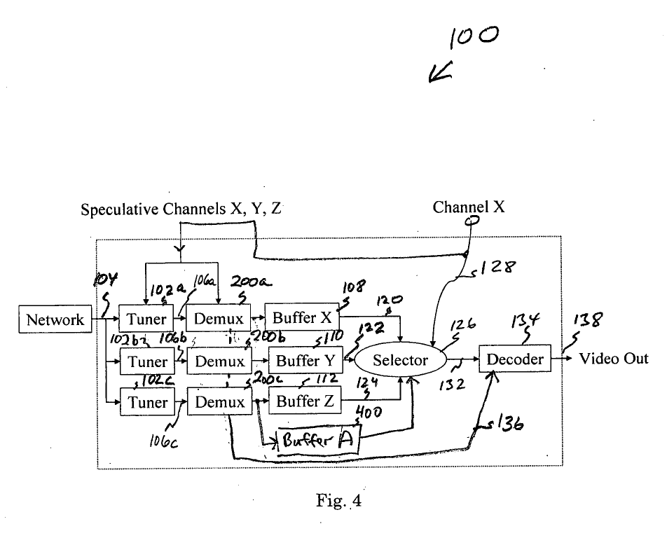

FIG. 4 is a schematic block diagram illustrating a third aspect of the system of FIG. 1. Shown is a plurality of tuners. Although three tuners 102a, 102b, and 102c are shown, the present invention system is not limited to any particular number of tuners. The tuners 102a-102c have interfaces on lines 104 to receive the multicast/broadcast compressed video channels and an interfaces on lines 106a through 106c, respectively, to supply a selected transport stream. Likewise, the system includes a plurality of demultiplexers. Again, the system is not limited to any particular number, but generally the number of demultiplexers equals the number of tuners. The demultiplexers 200a through 200c have interfaces on lines 106a-106c, respectively, connected to receive a corresponding transport stream. The demultiplexers 200a-220c have interfaces on lines 114-118 connected to supply information (program streams) extracted from the corresponding transport streams.

Note, another aspect of the system, not shown, incorporates features of both FIGS. 3 and 4. In this aspect the plurality of demultiplexers are connected to the buffer outputs on lines 120-126. In a different aspect, demultiplexers extract a plurality of program streams from a transport stream, and the plurality of program streams are buffered. For example, demultiplexer 200c supplies program streams to both buffer 112 and buffer 400.

Referencing either FIGS. 1, 2, 3, or 4, in some aspects of the system, every received channel is buffered. That is, the tuner 102 receives a first plurality of compressed video channels and supplies a first plurality of transport streams. Likewise a first plurality of buffers buffer information from the corresponding first plurality of transport streams.

Alternately, the number of buffers is limited and a decision must be made as to the channels to be buffered. That is, the tuner 102 receives a first plurality of compressed video channels and supplies a second plurality of transport streams, less than the first plurality, in response to commands received at an interface from the selector 126 (see FIG. 1 or 4). The selector 126 chooses the second plurality of transport streams for buffering using an algorithm such as channels neighboring an initially selected channel, a history of recently selected channels, a history of most-often selected channels, a history of selected channels cross-referenced to time, a history of selected channels cross-referenced to user, a history of selected channels cross-referenced to an initially selected channel, user-defined preferences, or learned user preferences.

In one aspect, the decoder 134 decodes an access point in the buffered information, discovers a real-time access point in the real-time compressed video channel received on line 136. The decoder 134 supplies a frozen image responsive to the buffered access point until the real-time access point is decoded, and begins video decoding in response to the decoding the real-time access point.

In another aspect, the tuner 102 supplies transport streams including video and audio data. The buffers 108-112 store the video and audio data, either as transport stream (FIG. 3) or program stream (FIG. 2) data. Then, the decoder 134 decodes the selected channels using the buffered information to maintain synchronization between the video and audio data.

### Functional Description

Consider a broadcast environment where several channels of video are available for access. Systems using compression such as MPEG-2 periodically insert I-frames, which interrupt temporal prediction, allowing users to access the video stream at the I-frames. The insertion of I-frames interrupts temporal prediction and, therefore, increases the bit rate necessary to carry the video at a given quality. A system designer trades off I-frame frequency against bit rate. In MPEG-2 applications, I-frames are typically inserted once or twice per second. In proposed low-bit rate simulcast using H.264, the use of Independent Decoder Refresh (IDR) pictures, the analog of the MPEG-2 I-frame, is recommended every two seconds, and an IDR cannot be absent for more than five seconds.

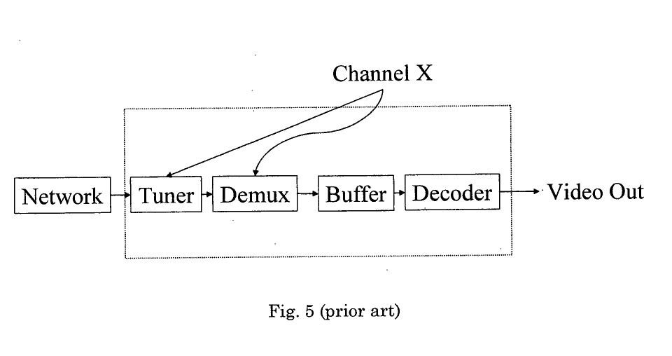

For purposes of illustration, assume that an I-frame is inserted every second for each video stream. Note, these I-frame insertions need not necessarily occur at the same time in each channel. Contrasting FIGS. 2 and 5, both the conventional system (FIG. 5) and the present invention system (FIG. 2), are receiving channel X. Because of the buffers, the present invention system is prepared for a low-delay switch to channel Y or Z. In this illustration it is assumed all channels can be received with a single tuner. This is the expected case for low bit rate simulcast. However, alternate aspects of this model cover cases where multiple tuners are needed.

The primary difference between the present invention and conventional systems is that the present invention receiver buffers data from channels not currently being viewed, in anticipation of a channel change. The buffers are large enough to always contain an access frame. Conventional architecture changes channels by altering the demultiplexer settings, and tuner setting if necessary. A different source of data is sent to the single buffer, after the buffer discards the bit stream for the old channel (see FIG. 5). The video decoder enters the stream at a random point and must wait for an access frame and any pre-roll delay. With the present invention receiver, however, a change from channel X, to either Y or Z, is achieved by using the selector. The selector picks the appropriate buffer and locates an access point within the buffer. The buffer contains data for an access frame. Therefore, delay is induced only by the need to locate and jump to an access frame, and not by the need to wait for an access frame to arrive. The delay can be further reduced to a smaller decoding delay by pre-locating the access I-frame.

Returning to FIG. 3 or 4, when the speculative channels cannot be demultiplexed from the output of a single tuner, additional tuners can be added to the architecture. These additional tuners send the appropriate data to each demultiplexer.

Selector

The selector operates in response to a channel change. If the change is to a channel that is currently stored in a buffer, the selector switches to this buffer, locates an access point, such as an I-frame, and passes compressed data to the decoder, both audio and video. In one implementation, the selector searches for an access point in response to a channel change request. In another implementation, the demultiplex operators provide information about the location of each access point in each buffer.

Speculative Channels

Given the large number of possible channels, the demultiplexing and buffering all channels is burdensome. To reduce this burden the concept of speculative channels is introduced. These are a set of one or more channels likely to be selected at the next channel change. The number of these channels is dictated by implementation complexity and the diminishing value of using more channels. A variety of techniques can be used to determine the set of speculative channels, ranging from a simple “Up” and “Down” algorithm, to more complex schemes. In one implementation, a receiver learns the set of likely channels. This information may be a first order probability or may include additional information such as current channel, current time, current day, current genus, user profile, etc.

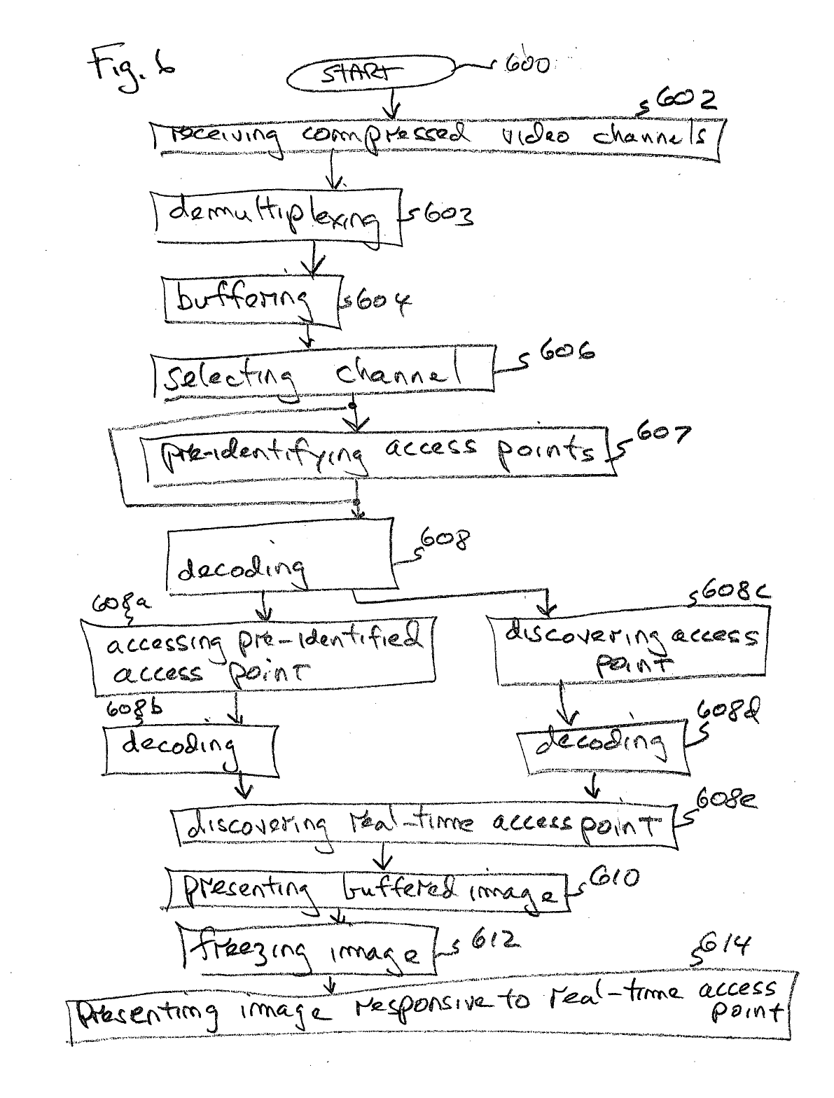

FIG. 6 is a flowchart illustrating the present invention method for low-delay channel changes in a multicast/broadcast of compressed video. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 600.

Step 602 receives a multicast/broadcast with a plurality of compressed video channels. For example, MPEG-1, MPEG-2, MPEG-4, H.261, H.263, or H.264 compressed video channels are received. Step 604 buffers information from a plurality of channels. Step 606 selects a channel. Step 608 decodes the selected channel in response to the buffered information.

In one aspect of the method, a further step, Step 607 pre-identifies access points in the buffered information for each channel prior to selecting the channel. Note, although shown following Step 606, Step 607 may occur either before or after Step 606. Then, decoding the selected channel in response to the buffered information in Step 608 includes substeps. Step 608a accesses the buffered information at the pre-identified access point. Step 608b decodes the selected channel, beginning at the access point. Alternately, Step 607 is not used and Step 608 includes different substeps. Step 608c, subsequent to selecting the channel, discovers an access point in the information buffered for the selected channel. Step 608d decodes the selected channel, beginning at the discovered access point.

For example, if Step 602 receives MPEG compressed video channels, then Step 608 decodes in response to a buffered Intra-coded frame (I-frame). If Step 602 receives H.264 compressed video channels, then Step 608 decodes in response to a buffered Independent Decoder Refresh (IDR) picture.

Buffering information from the plurality of channels in Step 604 includes buffering either transport stream or program stream information. In one aspect, Step 603 demultiplexes a plurality of transport streams to extract a plurality of program streams. Step 604, occurring after Step 603, stores each program stream in a corresponding buffer memory. In one variation, Step 603 serially demultiplexes the plurality of transport streams to extract the program streams. In a second variation, Step 603 parallely demultiplexes the plurality of transport streams to extract the program streams.

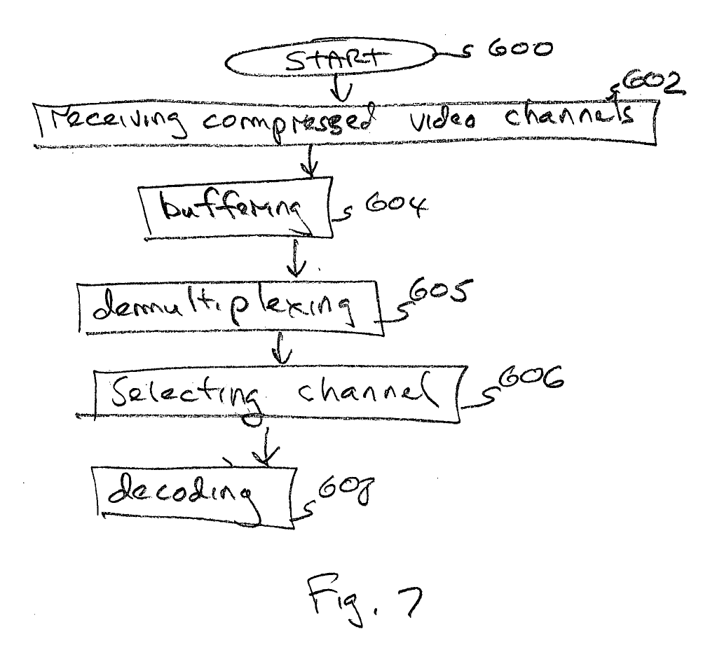

FIG. 7 is a flowchart illustrating an alternate aspect to the method of FIG. 6. In this aspect, buffering information from the plurality of channels in Step 604 includes storing each transport stream in a corresponding buffer memory. Then, Step 605, subsequent to buffering the information (Step 604), demultiplexes the plurality of transports streams to extract a plurality of program streams. As in FIG. 6, Step 605 may serially or parallely demultiplex. Although not shown, in other aspects of the method of FIG. 7, access points may be pre-identified (see Step 607 of FIG. 6).

Referring to either FIG. 6 or FIG. 7, in some aspects of the method, receiving a multicast/broadcast with a plurality of compressed video channels in Step 602 includes receiving a first plurality of channels, and Step 604 buffers data from a second plurality of channels, less than the first plurality. The second plurality of channels may be chosen using an algorithm such as channels neighboring an initially selected channel, a history of recently selected channels, a history of most-often selected channels, a history of selected channels cross-referenced to time, a history of selected channels cross-referenced to user, a history of selected channels cross-referenced to an initially selected channel, user-defined preferences, or learned user preferences.

In another aspect, receiving a multicast/broadcast with a plurality of compressed video channels in Step 602 includes receiving compressed video channels with video and audio data. Buffering information from a plurality of channels in Step 604 includes buffering the video and audio data. Then, decoding the selected channel in response to the buffered information in Step 608 includes using the buffered information to maintain synchronization between the video and audio data.

Returning to FIG. 6, decoding the selected channel in response to the buffered information includes decoding an access point in the buffered information (either Step 608b or Step 608d). Step 608e discovers a real-time access point in the selected channel. Step 610 presents an image in response to the buffered access point. Step 612 freezes the image until the real-time access point is decoded. Step 614 presents an image decoded in response to the real-time access point. Note, although not shown, the above-mentioned addition steps (Steps 608e, 610, 612, and 614) can also be added to the methodology of FIG. 7.

Systems and methods have been presented for the implementation of low-delay compressed video channel changing and decoding. A few examples have been provided to illustrate the present invention buffering concept. However, the invention is not limited to merely these examples. Other variations and embodiments of the invention will occur to those skilled in the art.

1. In a multicast/broadcast of compressed video, a method for low-delay channel changes, the method comprising:
receiving a multicast/broadcast with a plurality of compressed video channels;
buffering information from a plurality of channels;
selecting a channel; and,
decoding the selected channel in response to the buffered information.

2. The method of claim 1 wherein buffering information from the plurality of channels includes buffering information selected from the group including a transport stream and a program stream.

3. The method of claim 1 further comprising:
prior to selecting the channel, pre-identifying access points in the buffered information for each channel; and,
wherein decoding the selected channel in response to the buffered information includes:
accessing the buffered information at the pre-identified access point; and,
decoding the selected channel, beginning at the access point.

4. The method of claim 1 wherein decoding the selected channel in response to the buffered information includes:
subsequent to selecting the channel, discovering an access point in the information buffered for the selected channel; and,
decoding the selected channel, beginning at the discovered access point.

5. The method of claim 1 wherein receiving a multicast/broadcast with a plurality of compressed video channels includes receiving compressed video channels selected from the group including MPEG-1, MPEG-2, MPEG-4, H.261, H.263, and H.264.

6. The method of claim 1 wherein receiving a multicast/broadcast with a plurality of compressed video channels includes receiving MPEG compressed video channels; and,
wherein decoding the selected channel in response to the buffered information includes decoding in response to a buffered Intra-coded frame (I-frame).

7. The method of claim 1 wherein receiving a multicast/broadcast with a plurality of compressed video channels includes receiving H.264 compressed video channels; and,
wherein decoding the selected channel in response to the buffered information includes decoding in response to a buffered Independent Decoder Refresh (IDR) picture.

8. The method of claim 1 further comprising:
demultiplexing a plurality of transport streams to extract a plurality of program streams;
wherein buffering information from the plurality of channels includes storing each program stream in a corresponding buffer memory.

9. The method of claim 8 wherein demultiplexing a plurality of transport streams includes serially demultiplexing the plurality of transport streams to extract the program streams.

10. The method of claim 8 wherein demultiplexing a plurality of transport streams includes parallely demultiplexing the plurality of transport streams to extract the program streams.

11. The method of claim 1 wherein buffering information from the plurality of channels includes storing each transport stream in a corresponding buffer memory; and,
the method further comprising:
subsequent to buffering the information, demultiplexing the plurality of transports streams to extract a plurality of program streams.

12. The method of claim 1 wherein receiving a multicast/broadcast with a plurality of compressed video channels includes receiving a first plurality of channels; and,
wherein buffering information from a plurality of channels includes buffering data from a second plurality of channels, less than the first plurality.

13. The method of claim 12 wherein buffering data from a second plurality of channels includes choosing the second plurality of channels using an algorithm selected from the group including channels neighboring an initially selected channel, a history of recently selected channels, a history of most-often selected channels, a history of selected channels cross-referenced to time, a history of selected channels cross-referenced to user, a history of selected channels cross-referenced to an initially selected channel, user-defined preferences, and learned user preferences.

14. The method of claim 1 wherein decoding the selected channel in response to the buffered information includes:
decoding an access point in the buffered information;
discovering a real-time access point in the selected channel; and,
the method further comprising:
presenting an image in response to the buffered access point;
freezing the image until the real-time access point is decoded; and,
presenting an image decoded in response to the real-time access point.

15. The method of claim 1 wherein receiving a multicast/broadcast with a plurality of compressed video channels includes receiving compressed video channels with video and audio data;
wherein buffering information from a plurality of channels includes buffering the video and audio data; and,
wherein decoding the selected channel in response to the buffered information includes using the buffered information to maintain synchronization between the video and audio data.

16. A system for low-delay channel changes, the system comprising:
a tuner having a network interface to receive a multicast/broadcast with a plurality of compressed video channels and an interface to supply transport streams;
a plurality of buffers, each having an interface to receive information for a corresponding compressed video channel and an interface to supply the buffered information;
a selector having an interface to receive channel selection commands and an interface connected to the plurality of buffers, the selector supplying the buffered information at an output in response to channel selection commands; and,
a decoder having an interface to receive buffered information from the selector, the decoder supplying the selected channel at an output, decoded using the buffered information.

17. The system of claim 16 wherein the buffer buffers information selected from the group including a transport stream and a program stream.

18. The system of claim 16 further comprising:
a demultiplexer having an interface to receive transport streams from the tuner and an interface to supply a program streams, extracted from the transport stream, to the buffers.

19. The system of claim 16 further comprising:
a demultiplexer having an interface to receive buffered transport streams from the buffers and an interface to supply program streams, extracted from the transport stream, to the selector.

20. The system of claim 16 wherein the selector, prior to receiving channel selection commands, pre-identifies access points in the buffered information for each channel; and,
wherein the decoder accesses the buffered information at the pre-identified access point and decodes the selected channel, beginning at the access point.

21. The system of claim 16 wherein the decoder, subsequent to receiving the buffered information from the selector, discovers an access point in the information buffered for the selected channel and decodes the selected channel, beginning at the discovered access point.

22. The system of claim 16 wherein the tuner receives compressed video channels selected from the group including MPEG-1, MPEG-2, MPEG-4, H.261, H.263, and H.264.

23. The system of claim 16 wherein the tuner receives MPEG compressed video channels; and,
wherein the decoder supplies the selected channel decoded in response to an Intra-coded frame (I-frame) in the buffered information.

24. The system of claim 16 wherein the tuner receives H.264 compressed video channels; and,
wherein the decoder supplies the selected channel decoded in response to an Independent Decoder Refresh (IDR) picture in the buffered information.

25. The system of claim 16 wherein the tuner serially processes the plurality of received compressed video channels; and,
wherein the demultiplexer serially processes the plurality of transport streams.

26. The system of claim 16 further comprising:
a plurality of tuners, each having an interface to receive the multicast/broadcast compressed video channels and an interface to supply a selected transport stream; and,
a plurality of demultiplexers, each having an interface connected to receive a corresponding transport stream and an interface connected to supply program streams extracted from the transport stream.

27. The system of claim 16 wherein the tuner receives a first plurality of compressed video channels and supplies a first plurality of transport streams; and,
wherein a first plurality of buffers buffer information from the corresponding first plurality of transport streams.

28. The system of claim 16 wherein the tuner receives a first plurality of compressed video channels and supplies a second plurality of transport streams, less than the first plurality, in response to commands received at an interface from the selector;
wherein the selector chooses the second plurality of transport streams for buffering using an algorithm selected from the group including channels neighboring an initially selected channel, a history of recently selected channels, a history of most-often selected channels, a history of selected channels cross-referenced to time, a history of selected channels cross-referenced to user, a history of selected channels cross-referenced to an initially selected channel, user-defined preferences, and learned user preferences.

29. The system of claim 16 wherein the decoder has an interface connected to receive a real-time compressed video channel stream, and wherein the decoder decodes an access point in the buffered information, discovers a real-time access point in the real-time compressed video channel, supplies a frozen image responsive to the buffered access point until the real-time access point is decoded, and begins video decoding in response to the decoding the real-time access point.

30. The system of claim 16 wherein the tuner supplies transport streams including video and audio data;
wherein the buffers stores the video and audio data; and,
wherein the decoder decodes the selected channels using the buffered information to maintain synchronization between the video and audio data.
